(19) United States
(12) Patent Application Publication
(10) Pub. No.: US 2016/0369858 A1
(43) Pub. Date: Dec. 22, 2016

(54) DISC BRAKE CALIPER

(71) Applicant: NEWBRIDGE BRAKE LTD, Sheffield (GB)

(72) Inventors: Jonathan Leslie Christopher Jackson, Herefordshire (GB); Andrew James Dawson, Sheffield (GB)

(21) Appl. No.: 15/117,973

(22) PCT Filed: Feb. 12, 2015
(86) PCT No.: PCT/GB2015/050394

§ 371 Date: Aug. 10, 2016

(30) Foreign Application Priority Data
Feb. 14, 2014 (GB) 1402578.7

(51) Int. Cl. F16D 65/18; F16D 55/2255

(52) U.S. Cl. CPC F16D 65/183; F16D 55/2255; F16D 65/18; F16D 2055/0016

(57) ABSTRACT

A disc brake caliper for a vehicle includes a caliper housing, first and second tappets (16) mounted in the caliper housing for transmitting force to a brake pad, a bridge section (14) mounted across the first and second tappets, and a pivoting lever (12) for applying force to the bridge section (14), the bridge section in use transmitting the applied force to both tappets (16) simultaneously, and first and second return springs (20) disposed side by side provided between the bridge section (14) and a front wall of the caliper housing, for urging the bridge section (14) and both tappets (16) rearwardly into the caliper housing.

The present invention relates to a disc brake caliper for a vehicle, and particularly but not exclusively to a disc brake caliper for use with a compressed air braking system.

### BACKGROUND TO THE INVENTION

Disc brake calipers of the type which include a pair of tappets, a bridge section, and a pivoting lever which acts on the tappets via the bridge section, are well known. In such designs, a return spring is provided between the forward face of the caliper housing and the bridge section. However, in many cases there is an aperture in the forward face of the caliper housing which is closed by a cover plate. The return spring therefore bears against the cover plate which forms a large part of the front of the caliper housing. When the brake is operated, an actuating cylinder pushes one end of the pivoting lever, and the other end pushes on the bridge section which then transmits the force to the tappets to push the brake pad against the disc. When the brake is released, the return spring pushes the bridge section and hence the tappets back in the other direction, away from the brake disc and into the caliper housing.

The return spring must be strong enough to return the braking mechanism reliably. Failure to fully return the braking mechanism on the off-stroke may result in the pad not being moved completely clear of the disc, thus resulting in the brakes ‘running hot’, which reduces their effectiveness. However, a suitably strong spring puts a significant load on the cover plate. The cover plate must therefore be made from a reasonably thick material to provide for a reasonable fatigue life. However, such a material adds to the overall mass and cost of the brake. For economical vehicle operation, it is generally desirable to reduce the mass of all parts wherever possible.

EP2559909 discloses a cover plate which includes ribs to provide added strength, illustrating the overall push to remove material wherever possible.

It is an object of the invention to reduce or substantially obviate the above mentioned problems.

### SUMMARY OF THE INVENTION

According to the present invention, there is provided a disc brake caliper for a vehicle, the disc brake caliper including a caliper housing, first and second tappets mounted in the caliper housing for transmitting force to a brake pad, a bridge section mounted across the first and second tappets, and a pivoting lever for applying force to the bridge section, the bridge section in use transmitting the applied force to both tappets simultaneously, and first and second return springs disposed side-by-side between the tappets and between the bridge section and a front wall of the caliper housing, for urging the bridge section and both tappets rearwardly into the caliper housing.

Throughout this specification, the invention and its embodiments will be described with reference to a sliding caliper design, the front/forward side of the caliper being the side which is adjacent the brake disc, and the rear side of the caliper being the side which faces away from the brake disc. However, it will be appreciated that the invention can also be incorporated into a fixed caliper with a brake application unit on either side.

Note also that references to “horizontal” or “vertical” relate to the arrangement or parts substantially in the orientation shown in the Figures. Embodiments of the invention may in fact be mounted to vehicles in substantially any orientation.

Because two return springs are provided, the reaction force on the front of the housing is more spread out. As a result, the stress distribution is more even and the fatigue life is improved. This improvement can result in a caliper with a longer life, or alternatively the thickness of the cover plate may be reduced, resulting in a lighter brake caliper. Surprisingly, the improvement in stress more than offsets the cost of adding an additional spring. The dual-spring design also reduces vibration and oscillation within the brake caliper, in the brakes-off condition. In the two-spring design, the diameter of each spring can be reduced as compared to typical existing single-spring designs, and this allows for a more compact bridge profile and in turn a smaller caliper housing, both of which provide for a brake with lower overall mass for greater efficiency when installed on a vehicle.

The first and second return springs may preferably cover more than 35% of the linear distance between inner edges of the tappets. In a typical single-spring design, the spring only covers about 25% of the distance between the tappets. The increased footprint of the spring on the cover plate significantly reduces bending stresses in the cover plate.

First and second indents may be provided in a forward face of the bridge section for locating respectively the first and second springs. In the two-spring design, each of the two indents may be smaller than the size of the single indent found in a typical one-spring design. The large indent in known designs creates a stress distribution that dictates a very high grade of SG iron to achieve an acceptable fatigue life and strength. In particular, the material must have high tensile strength and high ductility. Supply of this high grade SG iron is limited. With the two-spring design, the smaller indents make for a more compact and stiff load beam, which can be made from a lower grade of material which is cheaper and more readily available. The bridge section can also be made using less material than in existing designs, providing lower mass and a more compact brake.

The pivoting lever typically acts on the bridge section at a point between the first and second tappets. This makes room for an adjuster in one of the tappets which can be removed or adjusted from the rear side of the caliper without having to remove the pivoting lever. However, a pivoting lever acting on the bridge between the tappets does result in bending of the bridge. The two-spring design reduces this problem because the indents in the bridge section for locating the two smaller springs provide for a better stress distribution in the bridge section than existing designs which have a large indent for receiving a single large spring.

An aperture may be provided in the front of the caliper, the aperture being closed by a cover plate which may be made from pressed steel. In other words, the front side of the housing, against which the first and second springs push, may in effect be a pressed steel cover plate. Providing an aperture in the front side of the caliper means that the mechanism inside the caliper can be assembled from the disc side, which results in certain advantages in terms of tooling, ease of assembly and sealing. However, the pressed steel cover plate is subject to bending stresses as a result of the action of the single return spring in known designs. The two-spring design reduces this problem because the increased footprint of the springs where they bear against the cover plate results in a smaller bending moment.

As a result of the improved stress distribution in the two-spring design, the thickness of the cover plate may be less than 1.6 mm, preferably less than 1.5 mm and most preferably less than 1.2 mm. This reduces the overall mass of the caliper.

First and second spring retainers protrude from a rear face of the cover plate. The spring retainers locate the springs in their correct position, preventing sliding.

The centres of each of the first and second springs may be disposed on a line which runs from the centre of the first tappet to the centre of the second tappet. Preferably, the centre of each of the first and second springs may be offset between 10 mm and 20 mm from the midpoint of the line between the centres of the first and second tappets, and the total distance between the outer edges of the first and second springs is more than 50 mm in the direction of the line between the centres of the first and second tappets.

### DESCRIPTION OF THE DRAWINGS

For a better understanding of the present invention, and to show more clearly how it may be carried into effect, reference will now be made by way of example only to the accompanying drawings, in which:

FIG. 1 shows a perspective view of an application unit, which is part of a brake caliper;

FIG. 2 shows an alternative perspective view of the application unit of FIG. 1, without two return springs which are shown in FIG. 1;

FIG. 3 shows a plan view from in front of the application unit of FIG. 2;

FIG. 4 shows a perspective view from behind of a cover plate, used for closing an opening in a disc brake caliper;

FIG. 5 shows a perspective view of a disc brake caliper which includes the application unit of FIGS. 1 to 3, and the cover plate of FIG. 4;

FIG. 6 shows a perspective view from behind of the disc brake caliper of FIG. 5; and

FIG. 7 shows a perspective view from behind of the disc brake caliper of FIG. 5, with a rear cover removed.

### DESCRIPTION OF A PREFERRED EMBODIMENT

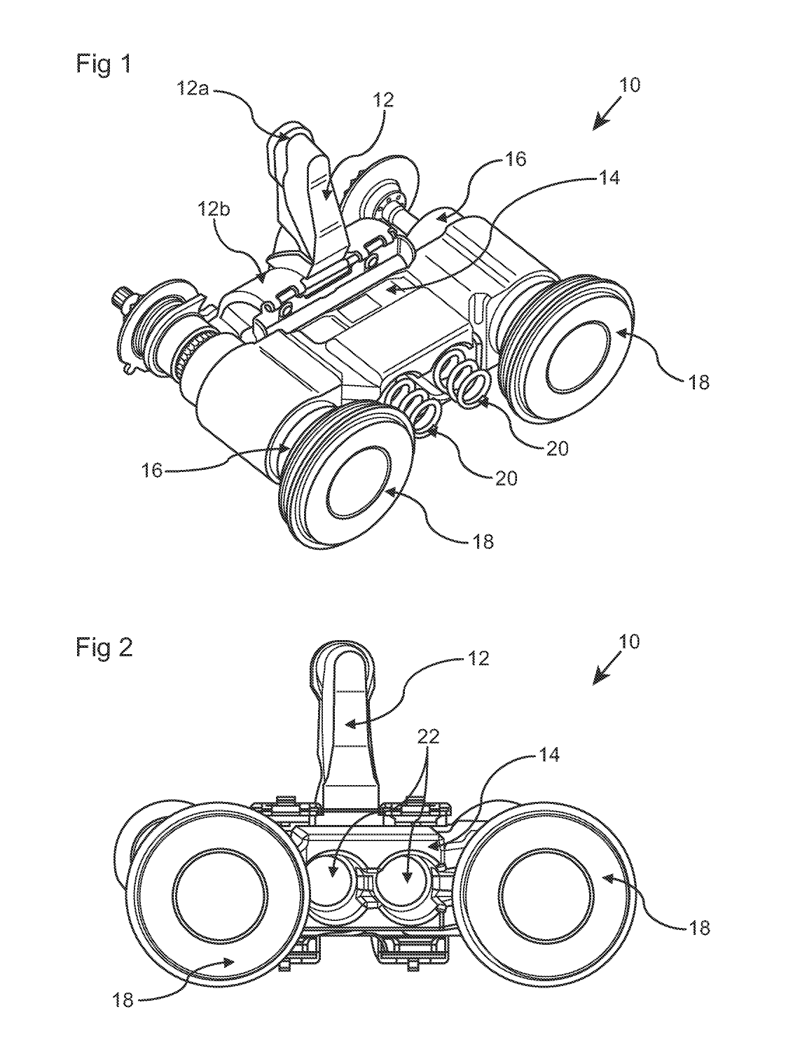

Referring firstly to FIG. 1, an application unit which forms part of a disc brake caliper is indicated generally at 10. The application unit includes a pivoting lever 12, which at one end has a bearing surface 12a which in use is pushed against by a brake actuator (for example, in a compressed air braking system, this would be an actuating cylinder). At the other end of the pivoting lever 12, a pair of eccentric journals 12b are provided. The eccentric journals 12b sit in bearings (not shown in FIG. 1) which are formed into the inside of the brake caliper housing. When the actuator pushes the pivoting lever 12, the eccentric journals 12b amplify the force, and transmit it to a bridge section 14. The bridge section in turn transmits the force to a pair of tappets 16, and hence to piston heads 18, which push the brake lining and brake pad against the brake disc.

Two return springs 20 are provided, and are disposed between the tappets 16 and between the bridge section 14 and the front of the brake caliper housing. The springs 20 are disposed side by side, with their centres substantially intersecting a line running from the centre of the first tappet to the centre of the second tappet. In other words, the springs are on a substantially horizontal line. A substantially vertical centreline of the application unit 10 runs in-between the two springs 20. FIG. 2 shows the application unit 10 with the springs (20) removed, exposing a pair of indents 22 in the bridge section 14. The indents 22 locate the springs (20) between the tappets, preventing any sideways movement of the springs (20).

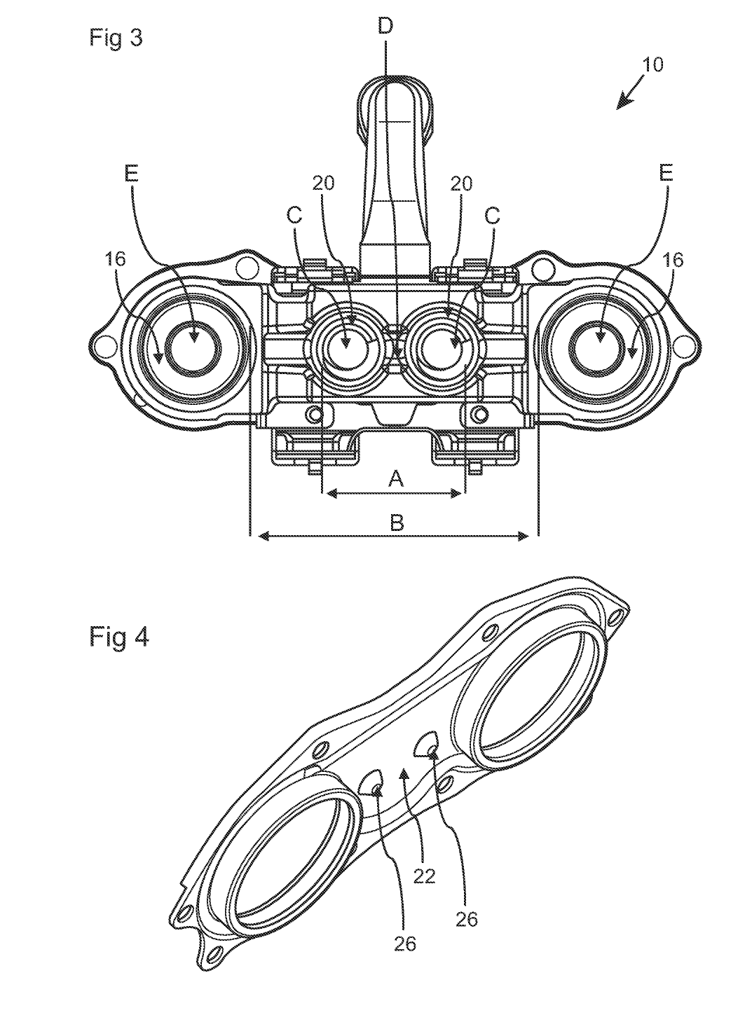

FIG. 3 shows the same brake application unit 10, but with the piston heads (18) removed and the springs 20 in place. FIG. 3 is a plan view from in front, and shows more clearly the relative dimensions and position of the springs 20 and the tappets 16. In this example, the horizontal distance between the outer edges of the springs 20 (dimension A in the Figure) is just over 50% of the total horizontal distance between outer edges of the tappets 16 (dimension B). The total horizontal extent of the springs (dimension A) is more than 50 mm and the centre of each of the springs 20, marked as point C and C′, is offset between 10 mm and 20 mm from the centre D of the line between the centres E, E′ of the first and second tappets 16.

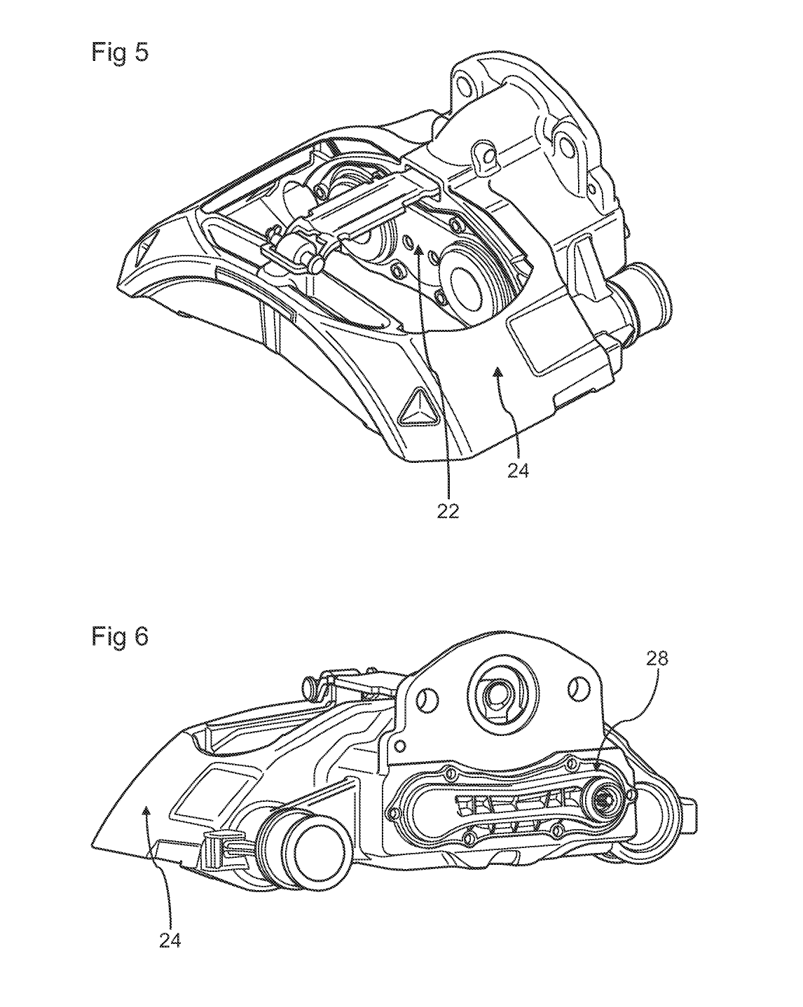

FIG. 4 shows a cover plate 22. As seen best in FIG. 5, the cover plate 22 is used to close off an aperture in the brake caliper housing 24 which is on the forward side of the caliper 24, i.e. adjacent the disc in a fully assembled brake. The cover plate 22 includes a pair of spring retaining protrusions 26, which locate the springs 20 where they bear against the cover plate 22 in use.

In this embodiment, the cover plate 22 effectively forms a substantial part of the front wall of the caliper housing 24. When assembled, the springs 20 are located in indents 22 in the bridge section 14 at one end, and on the spring retaining protrusions 26 in the cover plate 22 at the other end.

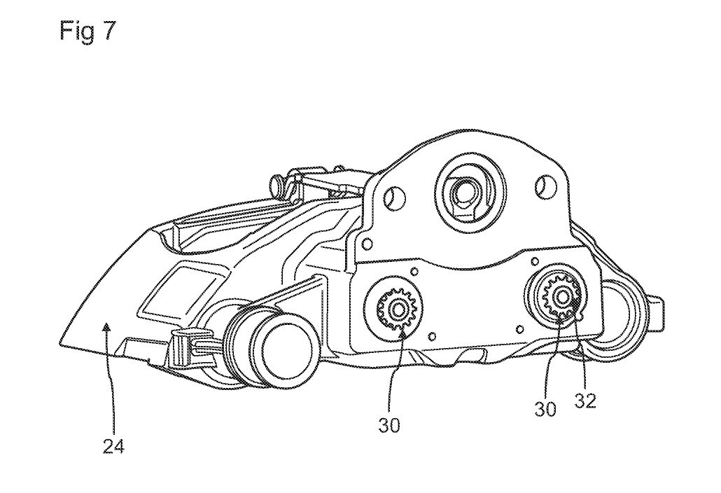

FIG. 6 and FIG. 7 show the brake caliper from behind. In FIG. 7 a rear cover plate 28 has been removed to expose synchronization gears 30, one on a rear end of each tappet 16, and an adjuster 32 positioned axially in-line with one of the tappets. When assembled, the synchronization gears 30 are connected by a timing belt or chain, so that when one tappet is rotated the other tappet rotates to the same degree. The adjuster 32 is adapted to turn one of the tappets when adjustment is required and the brake is applied. This mechanism is well-known and will be familiar to the skilled person.

The two-spring design reduces bending stresses on the cover plate and on the bridge section. This increases the fatigue life of these components or, alternatively, an acceptable fatigue life can be maintained whilst reducing the mass and/or cost of the parts by using less material, or a lower grade of material.

The embodiments described above are provided by way of example only, and various changes and modifications will be apparent to persons skilled in the art without departing from the scope of the present invention as defined by the appended claims. In particular, although the embodiment shown in the Figures has a caliper housing which is cast in one piece, it will be appreciated that a two-piece caliper housing may be provided in alternative embodiments of the invention as defined in the claims.

1. A disc brake caliper for a vehicle, the disc brake caliper including a caliper housing, first and second tappets mounted in the caliper housing for transmitting force to a brake pad, a bridge section mounted across the first and second tappets, a pivoting lever for applying force to the bridge section, and first and second return springs disposed side-by-side between the tappets and between the bridge section and a front wall of the caliper housing, in use, the bridge section transmitting the applied force to both tappets simultaneously and the return springs urging the bridge section and both tappets rearwardly into the caliper housing.

2. A disc brake caliper as claimed in claim 1, in which the springs cover more than 35% of the linear distance between inner edges of the tappets.

3. A disc brake caliper as claimed in claim 1, in which first and second indents are provided in a forward face of the bridge section for locating respectively the first and second springs.

4. A disc brake caliper as claimed in claim 1, in which the pivoting lever acts on the bridge section at a point between the first and second tappets.

5. A disc brake caliper as claimed in claim 1, in which an aperture is provided in the front of the caliper, the aperture being closed by a cover plate.

6. A disc brake caliper as claimed in claim 5, in which the cover plate is made from pressed steel.

7. A disc brake caliper as claimed in claim 5, in which the thickness of the cover plate is less than 1.6 mm.

8. A disc brake caliper as claimed in claim 7, in which the thickness of the cover plate is less than 1.5 mm.

9. A disc brake caliper as claimed in claim 8, in which the thickness of the cover plate is less than 1.2 mm.

10. A disc brake caliper as claimed in claim 5, in which first and second spring retainers protrude from a rear face of the cover plate.

11. A disc brake caliper as claimed in claim 1, in which the centre of each of the first and second springs is offset between 10 mm and 20 mm from the midpoint of a line running from the centre of the first tappet to the centre of the second tappet.

12. A disc brake caliper as claimed in claim 1, in which the total distance between the outer edges of the first and second springs is more than 50 mm in the direction of a line running from the centre of the first tappet to the centre of the second tappet.

13. (canceled)

14. A disc brake caliper for a vehicle, the disc brake caliper including a caliper housing, first and second tappets mounted in the caliper housing for transmitting force to a brake pad, a bridge section mounted across the first and second tappets, a pivoting lever for applying force to the bridge section, and first and second return springs disposed side-by-side between the tappets and between the bridge section and a front wall of the caliper housing, the springs covering more than 35% of the linear distance between inner edges of the tappets and the centre of each of the first and second springs being offset between 10 mm and 20 mm from the midpoint of a line running from the centre of the first tappet to the centre of the second tappet, in use, the bridge section transmitting the applied force to both tappets simultaneously and the return springs urging the bridge section and both tappets rearwardly into the caliper housing.

15. A disc brake caliper as claimed in claim 14, in which the total distance between the outer edges of the first and second springs is more than 50 mm in the direction of a line running from the centre of the first tappet to the centre of the second tappet.

16. A disc brake caliper as claimed in claim 14, in which an aperture is provided in the front of the caliper, the aperture being closed by a cover plate.

17. A disc brake caliper as claimed in claim 14, in which first and second indents are provided in a forward face of the bridge section for locating respectively the first and second springs.

18. A disc brake caliper for a vehicle, the disc brake caliper including a caliper housing, first and second tappets mounted in the caliper housing for transmitting force to a brake pad, a bridge section mounted across the first and second tappets, a pivoting lever for applying force to the bridge section, and first and second return springs disposed side-by-side between the tappets and between the bridge section and a front wall of the caliper housing, the springs covering more than 35% of the linear distance between inner edges of the tappets and the total distance between the outer edges of the first and second springs being more than 50 mm in the direction of a line running from the centre of the first tappet to the centre of the second tappet, in use, the bridge section transmitting the applied force to both tappets simultaneously and the return springs urging the bridge section and both tappets rearwardly into the caliper housing.

19. A disc brake caliper as claimed in claim 18, in which the centre of each of the first and second springs is offset between 10 mm and 20 mm from the midpoint of a line running from the centre of the first tappet to the centre of the second tappet.

20. A disc brake caliper as claimed in claim 18, in which an aperture is provided in the front of the caliper, the aperture being closed by a cover plate.

21. A disc brake caliper as claimed in claim 18, in which first and second indents are provided in a forward face of the bridge section for locating respectively the first and second springs.
